(19) United States
(12) Patent Application Publication
(10) Pub. No.: US 2004/0205468 A1
(43) Pub. Date: Oct. 14, 2004

(54) Web page author

(76) Inventor: Thomas Lightner, Broomfield, CO (US)

Correspondence Address: BLAKELY, SOKOLOFF, TAYLOR & ZAFMAN LLP, Seventh Floor, 12400 Wilshire Boulevard, Los Angeles, CA, 90025-1030, US

(21) Appl. No.: 10/150,265

(22) Filed: May 17, 2002

(51) Int. Cl. G06F 17/24; G06F 17/21

(52) U.S. Cl. 715/500; 715/513

(57) ABSTRACT

Disclosed are novel methods and apparatus for providing, for example, automated, efficient Web page authoring systems to assist in creation of Web pages with a similar look and/or feel relatively quickly. In an embodiment, a method of providing a plurality of Web pages is disclosed. The method may include: building an initial Web page corresponding to the plurality of Web pages; providing an input section to enter data into; providing an output section to output data to; providing a process section to process data based on the input section data and output the processed data to the output section; identifying variable data present in the initial Web page; and creating at least one formula in the output section to reconstitute code corresponding to the identified variable data.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. The following notice applies to the software and data as described below and in the drawings hereto: Copyright © 2002, Sun Microsystems, Inc., All Rights Reserved.

### FIELD OF INVENTION

The present invention generally relates to the field of Web pages. More specifically, an embodiment of the present invention provides an automated, efficient Web page authoring systems to assist in creation of Web pages with a similar look and/or feel quickly.

### BACKGROUND OF INVENTION

As the Internet becomes increasingly a part of everyday life, the number of Web pages created is growing exponentially. For example, most businesses utilize the Internet to advertise and in many cases provide their services. Each Web site though often needs to maintain its look across all its Web pages. This may help in informing a visitor that even though a different page may be displayed the user is still on the same Web site. The look and feel of a Web site also assists in promoting that Web site's unique persona (similar to a trademark).

The practice of using similar Web pages with different values for particular fields is common today but requires higher level skills than, for example, spreadsheet and text file expertise. Generally, only programmers with expertise in programming and scripting can create Web sites with dynamic Web page content. These Web pages are often implemented utilizing a hyper text markup language (HTML).

Presently, there are several Web authoring programs available for creating Web pages. These programs, however, are better at creating initial Web pages rather than many similar pages. These programs often include extraneous code as a result of their general-purpose nature. The required extraneous code, however, creates inefficiencies.

With the growth in utilization of the Internet by less technically-oriented authors, many Web pages need to be created by people with little or no advanced HTML and related skills. Additionally, the Web pages often include references in several ways to database IDs. These database IDs have to match exactly to work properly. The manual process for creating Web pages often results in many errors in part because of the sensitivity of the computer implementations to errors inherently created through a manual process.

### SUMMARY OF INVENTION

The present invention, which may be implemented utilizing a general-purpose digital computer, in some embodiments, includes novel methods and apparatus to provide automated, efficient Web page authoring systems to assist in creation of Web pages with a similar look and/or feel. In an embodiment, a method of providing a plurality of Web pages is disclosed. The method may include: building an initial Web page corresponding to the plurality of Web pages; providing an input section to enter data into; providing an output section to output data to; providing a process section to process data based on the input section data and output the processed data to the output section; identifying variable data present in the initial Web page; and creating at least one formula in the output section to reconstitute code corresponding to the identified variable data.

In another embodiment, the reconstituted code may assist in provision of the plurality of Web pages and the plurality of Web pages provide at least one of a same look and a same feel.

In a further embodiment, the method may further include creating at least one function in the process section to assist in provision of data in the output section.

### BRIEF DESCRIPTION OF DRAWINGS

The present invention may be better understood and its numerous objects, features, and advantages made apparent to those skilled in the art by reference to the accompanying drawings in which:

FIG. 1 illustrates an exemplary computer system 100 in which the present invention may be embodied;

FIGS. 2A and 2B illustrate exemplary flow methods (200 and 250) indicating the duties of a designer and a user in accordance with various embodiments of the present invention, respectively;

FIG. 3A illustrates an exemplary portion of an output WS 300 in accordance with an embodiment of the present invention;

FIG. 3B illustrates an exemplary portion of an input WS 350 in accordance with an embodiment of the present invention;

FIG. 4 illustrates an exemplary user responsibility method 400 in accordance with an embodiment of the present invention; and

FIG. 5 illustrates an exemplary user responsibility method 500 in accordance with an embodiment of the present invention.

The use of the same reference symbols in different drawings indicates similar or identical items.

### DETAILED DESCRIPTION

In the following description, numerous details are set forth. It will be apparent, however, to one skilled in the art that embodiments of the invention may be practiced without these specific details. In other instances, well-known structures, devices, and techniques have not been shown in detail, in order to avoid obscuring the understanding of the description. The description is thus to be regarded as illustrative instead of limiting.

Reference in the specification to “one embodiment” or “an embodiment” means that a particular feature, structure, or characteristic described in connection with the embodiment is included in at least an embodiment of the invention. The appearances of the phrase “in one embodiment” in various places in the specification are not necessarily all referring to the same embodiment.

In addition, select embodiments of the present invention include various operations, which are described herein. The operations of the embodiments of the present invention may be performed by hardware components or may be embodied in machine-executable instructions, which may be in turn utilized to cause a general-purpose or special-purpose processor, or logic circuits programmed with the instructions to perform the operations. Alternatively, the operations may be performed by a combination of hardware and software.

Moreover, embodiments of the present invention may be provided as computer program products, which may include machine-readable medium having stored thereon instructions used to program a computer (or other electronic devices) to perform a process according to embodiments of the present invention. The machine-readable medium may include, but is not limited to, floppy diskettes, optical disks, compact disc-read only memories (CD-ROMs), and magneto-optical disks, read-only memories (ROMs), random-access memories (RAMs), erasable programmable ROMs (EPROMs), electrically EPROMs (EEPROMs), magnetic or optical cards, flash memory, or other types of media or machine-readable medium suitable for storing electronic instructions and/or data.

Additionally, embodiments of the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

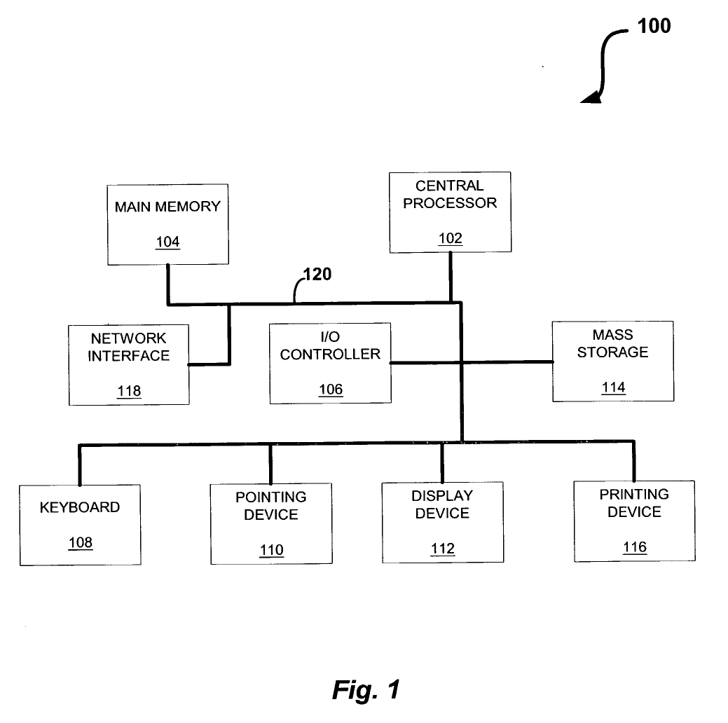

FIG. 1 illustrates an exemplary computer system 100 in which the present invention may be embodied in certain embodiments. The system 100 comprises a central processor 102, a main memory 104, an input/output (I/O) controller 106, a keyboard 108, a pointing device 110 (e.g., mouse, track ball, pen device, or the like), a display device 112, a mass storage 114 (e.g., a nonvolatile storage such as a hard disk, an optical drive, and the like), and a network interface 118. Additional input/output devices, such as a printing device 116, may be included in the system 100 as desired. As illustrated, the various components of the system 100 communicate through a system bus 120 or similar architecture.

In an embodiment, the computer system 100 includes a Sun Microsystems computer utilizing a SPARC microprocessor available from several vendors (including Sun Microsystems of Santa Clara, Calif.). Those with ordinary skill in the art understand, however, that any type of computer system may be utilized to embody the present invention, including those made by Hewlett Packard of Palo Alto, Calif., and IBM-compatible personal computers utilizing Intel microprocessor, which are available from several vendors (including IBM of Armonk, N.Y.). In addition, instead of a single processor, two or more processors (whether on a single chip or on separate chips) can be utilized to provide speedup in operations. It is further envisioned that the processor 102 may be a complex instruction set computer (CISC) microprocessor, a reduced instruction set computing (RISC) microprocessor, a very long instruction word (VLIW) microprocessor, a processor implementing a combination of instruction sets, and the like.

The network interface 118 provides communication capability with other computer systems on a same local network, on a different network connected via modems and the like to the present network, or to other computers across the Internet. In various embodiments, the network interface 118 can be implemented utilizing technologies including, but not limited to, Ethernet, Fast Ethernet, wide-area network (WAN), leased line (such as T1, T3, optical carrier 3 (OC3), and the like), analog modem, digital subscriber line (DSL and its varieties such as high bit-rate DSL (HDSL), integrated services digital network DSL (IDSL), and the like), cellular, time division multiplexing (TDM), universal serial bus (USB and its varieties such as USB II), asynchronous transfer mode (ATM), satellite, cable modem, and/or FireWire.

Moreover, the computer system 100 may utilize operating systems such as Solaris, Windows (and its varieties such as CE, NT, 2000, XP, ME, and the like), HP-UX, IBM-AIX, PALM, UNIX, Berkeley software distribution (BSD) UNIX, Linux, Apple UNIX (AUX), and the like. Also, it is envisioned that in certain embodiments, the computer system 100 is a general purpose computer capable of running any number of applications such as those available from companies including Oracle, Siebel, Unisys, Microsoft, and the like.

I. Page Author Embodiment

The Page Author embodiment may be used to quickly create multiple Web pages from a spreadsheet template. The spreadsheet may be selected from any number of spreadsheets available such as StarCalc (provided by Sun Microsystems, Inc., of Santa Clara, Calif.), Microsoft Excel or Microsoft Works (both provided by Microsoft Corporation of Redmond, Wash.), Quattro Pro (available from Corel Corporation of Ottawa, Ontario, Canada), ClarisWorks (now called AppleWorks, available from Apple Computers of Cupertino, Calif.), and/or Lotus 123 (available from IBM of Armonk, N.Y.). The Page Author embodiment may utilize two sets of expertise, one for a designer and another for a user. In one embodiment, these skills may be provided by a same user.

In an embodiment, the designer should have a background in spreadsheet and basic HTML technologies. The required expertise in spreadsheets should extend to formulas and functions. The degree of spreadsheet function sophistication depends on the complexity of the implementation. The minimum HTML coding knowledge should include the ability to code in basic HTML tags such as lists, links, and tables. The coding can be done by hand or with an HTML authoring package. If using an authoring package, the designer should at least be able to manipulate the text that is generated by the authoring package.

In another embodiment, the user's background should include the ability to make entries in a spreadsheet, copying and pasting, and testing Web pages to see if the Web page looks and/or feels as desired. Optionally, it would be beneficial to help the designer if the user can also tweak the HTML code in the case that the designer's implementation requires modification.

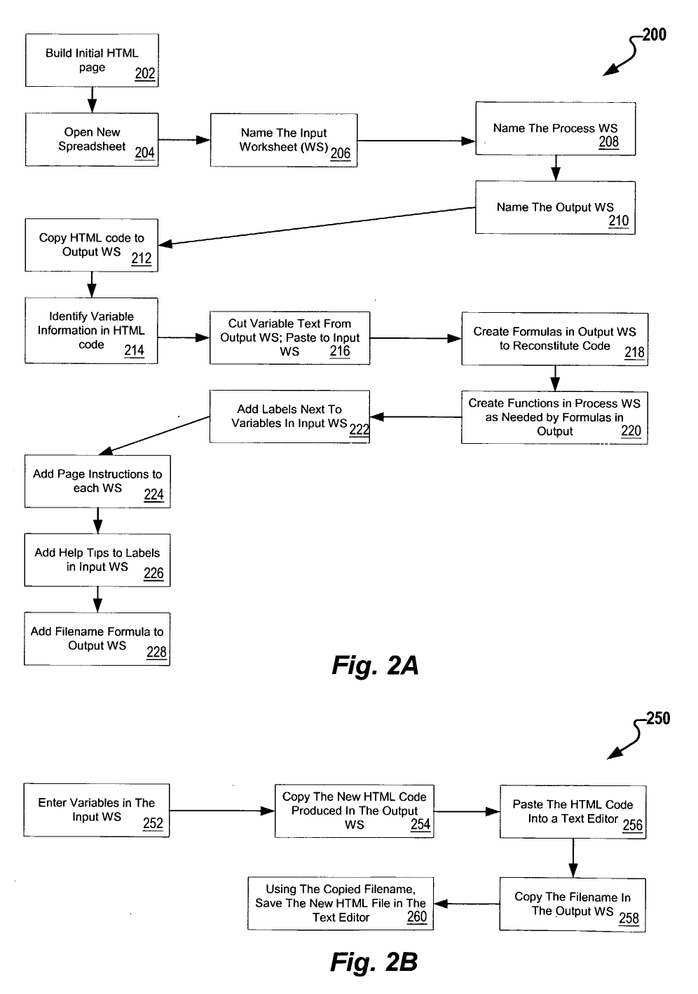

FIGS. 2A and 2B illustrate exemplary flow methods (200 and 250) indicating the duties of a designer and a user in accordance with various embodiments of the present invention, respectively. With respect to FIG. 2A, the responsibilities of the designer include building an initial page (step 202), either manually or with the use of a Web authoring program for example. The tool that builds the HTML pages in the Page Author embodiment may be a spreadsheet in an embodiment. In a step 204, the designer opens a new spreadsheet. In one embodiment, the spreadsheet may need at least three areas for organizational purposes, for example. In an embodiment, these three areas may be implemented as separate pages or worksheets (WS). For the sake of the example, these worksheets may be referred to as input, process, and output worksheets (which may be named by, for example, the designer in steps 206-210, respectively).

A step 212 the HTML code may be copied to the output WS. In a step 214, the designer segregates variable information from the code in the output page. This may involve the following steps:

a. cut text identified as variable and paste each variable string into a cell in the input WS (step 216);

b. create formulas in the output WS to reconstitute code (the formulas may utilize the variable strings in the input WS) (step 218);

c. create functions in the process WS to facilitate formulas in the output WS, as needed (step 220); and/or

d. add labels in the input WS next to the variable strings (step 222).

In a step 224, page instructions may be added to each WS. A step 226 may add help tips to each label in the input WS. In a step, the designer may create a formula in the output WS that may return a unique filename according to a predetermined pattern for the HTML pages that may be created with the Page Author embodiment. In an embodiment of the present invention, it is envisioned that some of the steps discussed with respect to FIG. 2A may provide better usability but may be ultimately optional (such as the steps 206, 208, 210, 216, and 222-226).

With respect to FIG. 2B, the responsibilities of the user may include accessing the completed spreadsheet tool of FIG. 2A (not shown). In a step 252, new variables may be entered into the input WS as required. This may, in turn, result in changes to the HTML code in the output WS. In a step 254, the user may copy the HTML code from the output WS to the clipboard or other temporary location for utilization later. The user then may paste the HTML code from the clipboard to the text editor (step 256). In an embodiment, the steps 254 and 256 may be implemented in a single step, for example by copying directly from the output WS into the text editor. In a step 258, the user may copy the filename in the output WS to the clipboard or other temporary location for future reference. In a step 260, the user saves the HTML code in the text editor by utilizing the filename copied in the step 258, for example, at the appropriate time, the user may paste the filename from the clipboard into the Save As dialog window. In an embodiment, the steps 258 and 260 may be implemented in a single step, for example by referencing the output WS during a save command.

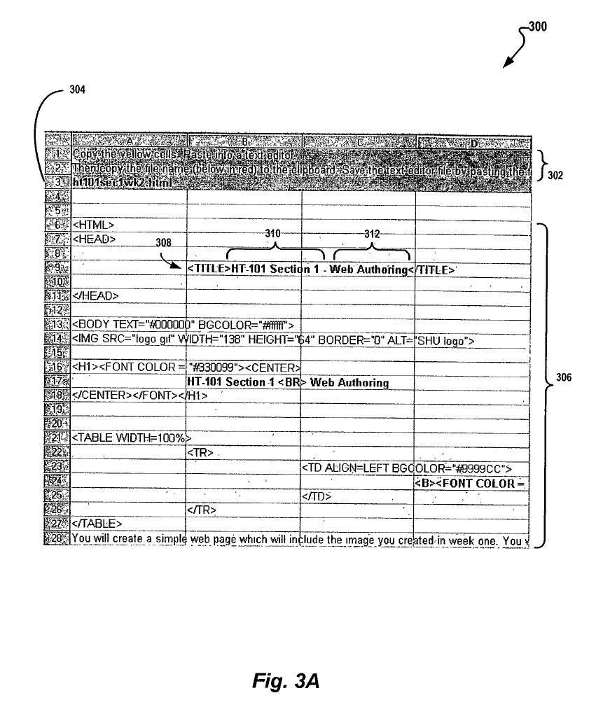

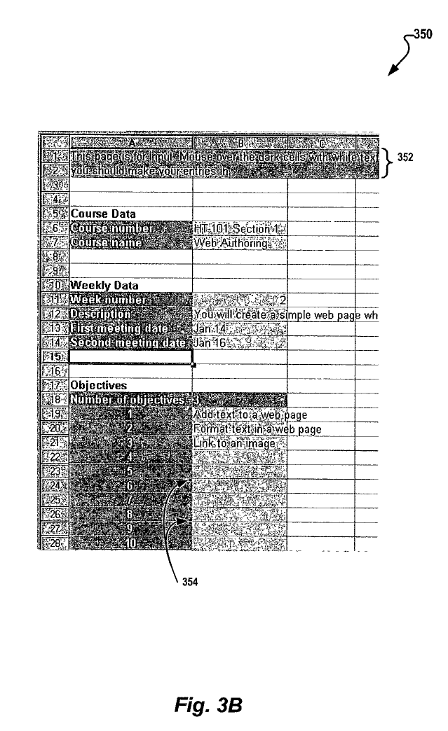

FIG. 3A illustrates an exemplary portion of an output WS 300 in accordance with an embodiment of the present invention. The output WS 300 includes a portion 302 which includes the page instructions. The output WS 300 also includes a filename in a portion 304, for example, to be used to save the HTML file when ready (see, e.g., the steps 258 and 260 of FIG. 2B). The top section of the HTML code (306), starting in cell A6, may be created by the designer. In an embodiment, the HTML code can be written using straight HTML coding. In another embodiment, the code can be generated using an HTML authoring tool, with cleanup following use of the authoring tool. The cleanup may be done manually in an embodiment to remove extraneous code. The authoring tool may be selected from any of the available products on the market including, but not limited to, FrontPage (available from Microsoft Corporation of Redmond, Wash.), Adobe GoLive or PageMill (both available from Adobe Systems, Inc., of San Jose, Calif.), Dreamweaver (available from Macromedia, Inc., of San Francisco, Calif.), HotDog (available from Sausage Software of Australia), and/or HoTMetaL Pro (available from SoftQuad of Ottawa, Canada, which was recently acquired by Corel Corporation of Ottawa, Canada).

There are two things to note about the HTML code presented in the spreadsheet environment. First, each line of code that appears in the worksheet may be actually stored in a single cell, even though most visually appear to overlap to adjacent columns. The lines that are indented, for example, the line starting with a <TITLE> tag in cell B9 (308), are indented because tabs were used to indent the text in the original text file and the spreadsheet treats each tab as a delimiter. Thus, the formatting of the indentations can be preserved. Second, some cells, such as B9 (308), are bold. The bolding may be done manually to visually distinguish which rows include variable information. For example, with respect to cell B9 (308), there are two strings of variable information: (1) “HT-101 Section 1” (310) (e.g., indicating the course number and section number); and (2) “Web Authoring” (312) (e.g., indicating the course name).

Each bold entry may contain some information that is variable and some that is constant. In an embodiment, these entries should be converted into formulas that might also contain functions (see, e.g., the steps 218 and 220 of FIG. 2A). Every other entry (non-bold) can be left alone since the text may remain constant for every HTML page that is produced. It is also envisioned that in one embodiment coloring may be utilized to highlight portions of the WS that may need user involvement (see, e.g., the instructions 302).

FIG. 3B illustrates an exemplary portion of an input WS 350 in accordance with an embodiment of the present invention. The input WS 350 includes an instruction portion 352 at the top. This worksheet displays labels in the A column for each variable that is input in the B column. A square 354 in the upper right corner of each label cell indicates that there is a help tip available for the corresponding input. In an embodiment, holding the mouse over that cell with the square may reveal the tip.

As discussed with respect to FIG. 2A, the designer may move text from the output WS (e.g., of FIG. 3A) into these B column cells. The designer then may use these cells as variable text strings in order to create formulas and functions that may reproduce the original HTML code prior to the removal of this variable information. As discussed with respect to FIG. 2B, the user may use the input WS 350 to enter new variable information corresponding to a new week or new course section, for example.

In an embodiment, to reconstitute the code so that it appears exactly the same, a cell may be replaced with the formulas such as the following:

=“<TITLE>“&input.B6&”—“&input.B7&”</TITLE>”

In one embodiment, concatenation formulas may be utilized such as the following:

=“constant1”&variable1&“constant2”&variable2&”constant3”

wherein, each constant is enclosed by quotes and each variable is a cell reference, such as input.B6 indicating cell B6 of the input WS.

These formulas may make the HTML code in a given cell appear exactly the same as it did prior to moving the variable text strings and writing the concatenation formula. One advantage of this embodiment is that when the corresponding input cells change (for example, for the next HTML page that is being produced), this block of code may automatically reflect the desired code for the new HTML page.

In one embodiment, by using smaller text strings for variables (for example, breaking apart “HT—101 Section 1” and “Web Authoring,” the strings may be more easily used in different portions of the worksheet (for example by utilizing concatenation formulas and the like).

In the embodiments where the concatenation formula syntax conflicts with special characters used in the HTML code, a concatenation formula may be utilized instead. For example, the concatenation formula may fail because it may enclose quotes around a text string that also includes quotes. In an embodiment, a process WS (or, alternatively, a different portion or section of a WS) may be utilized to store intermediate formulas or functions to solve more complicated problems than those solved with a simple concatenation formula. A sample concatenation formula may be:

=CONCATENATE(A6;A7;A8)

wherein, one or more of the cells A6-A8 may include more complex expressions.

In further embodiments, other functionalities of a spreadsheet program may be utilized to ensure that a variable number of items in a given cell are accounted for. In particular, a count function (e.g., COUNTA) and a lookup function (VLOOKUP) may be utilized to determine the number of variables in a given cell and then extract the appropriate item from the information within the given cell.

In one embodiment, it may be beneficial to have a standardized naming convention for the files, since some of the embodiments of the present invention may be utilized to write many HTML files. In an embodiment for the example discussed herein, the file naming may be accomplished by concatenating sections of the course name and section number with the week number and adding the “.HTML” file extension. In an embodiment, a process WS (or, alternatively, a different portion or section of a WS) may be utilized to create the file names. A lower case function (e.g., LOWER) in conjunction with left, mid, and right functions (which may extract the appropriate information from a string) may be utilized in an embodiment.

II. Course Builder Embodiment

Course Builder is an implementation of Page Author in accordance with an embodiment of the present invention. Course Builder may be used to facilitate the process of adding new content to a skills database (such as the SunSkills database provided by Sun Microsystems, Inc., of Santa Clara, Calif.) and provide related information to the users of the skills database. In accordance with an embodiment of the present invention, a database is envisioned to include any collection of data that is organized for collection and/or retrieval. Course Builder may build several files or parts of files related to courses that are subsequently used in or related to courses (or learning events) in the skills database.

In one embodiment, two comma separated values (CSV) files may be created that can be used to bulk load course data and skills data into the skills database. The first file may be referred to known as the A table file which primarily comprises course data. The second file may be referred to as the B table file, which primarily includes skills data.

In a further embodiment, the Course Builder may build parts of the HTML code that can be used in existing HTML files. It may build a table row that will be inserted into a table in one of several HTML files. The set of files may be referred to as a collection of course maps. Course Builder may also build an HTML text line that can be inserted into a course index file, for example, for indexing purposes.

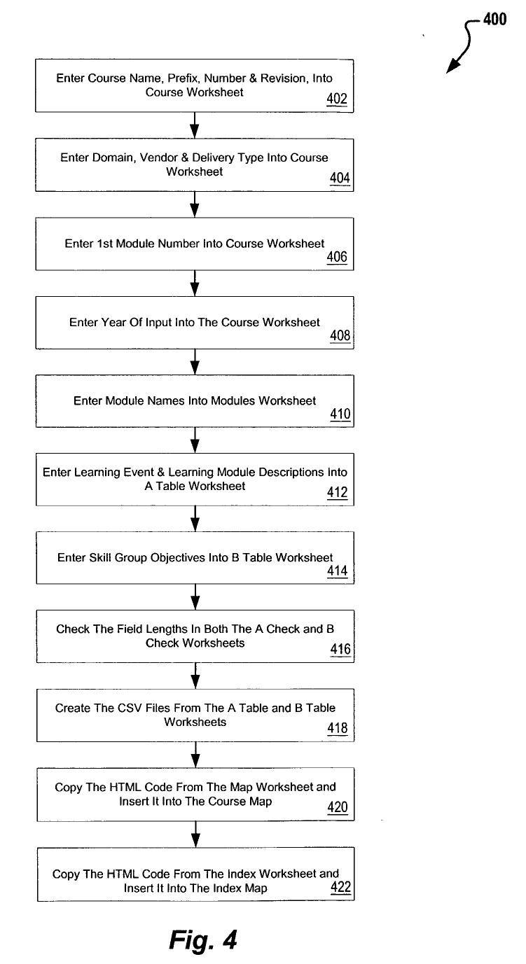

FIG. 4 illustrates an exemplary user responsibility method 400 in accordance with an embodiment of the present invention. The method 400 includes a step 402 in which a user enters the name, prefix, number and revision of a course into a course worksheet. In a step 404, domain, vendor, and delivery type are entered into the course worksheet. A step 406 enters the first module number of the course into the course worksheet. In a step 408, the year of input is entered into the course worksheet. A step 410 enters the module names into a modules worksheet. In a step 412, the user enters any learning event and/or learning module descriptions into the A table worksheet. In a step 414, the user enters skill group objectives (which may be stored in an objectives file in an embodiment) into the B table worksheet. A step 416 checks the field lengths in the A check and B check worksheets. In an embodiment, the step 416 may perform other tests such as correct data type test (e.g., numerals versus alphabetical, range limits, and the like). In a step 418, CSV files are created from the A table and B table worksheets. The user copies the HTML code from the map worksheet into the course map worksheet in a step 420.

In a step 422, the user copies the HTML code from an index worksheet into the index map worksheet. In one embodiment, the index worksheet may create HTML code that produces a single line of text for the course index map. In another embodiment, each time Course Builder is used to create outputs for a new course, the index worksheet can provide a new line of HTML code which is inserted into an existing index HTML file. Thus, the modified HTML file may grow by one line with each successive use of the Course Builder.

In an embodiment, even though different worksheets are specified with respect to FIG. 4, it is envisioned that different areas of a same worksheet may be utilized to achieve the same goals without departing from the spirit of the invention. In one embodiment, the user of Course Builder may follow the spreadsheet from worksheet to worksheet to produce the deliverables. Each WS may include general instructions highlighted with, for example a color. Each cell or range of cells that requires a user operation may include help tips that can be viewed, for example, by moving the mouse over a labeled cell.

In various embodiments, the set of worksheets may include any combination of the following:

1. Legend (the user may refer to this WS to assist in following instructions of other worksheets);

2. Course (which may include any combination of the following entries: name, course prefix, course number, revision, domain, vendor, delivery type, first module, language, country, description, year, and/or objective filename such as those discussed with respect to FIG. 4);

3. Modules (which may include any combination of the following: module number, module name, module description, and/or module objectives);

4. A table (which may include course data plus basic module information such as any combination of the following: language, country, domain ID, learning event ID, learning event name, learning event description, delivery ID, vendor ID, learning module ID, learning module name, and/or learning module description);

5. B table (which may include skills data such as any combination of the following: language, country, domain, skill group ID, skill group name, skill group objectives, learning domain ID, learning event ID, and/or learning module ID);

6. A check (which may perform a check on the A table prior to loading the data such as discussed with respect to the step 416 above);

7. B check (which may perform a check on the B table prior to loading the data such as discussed with respect to the step 416 above);

8. MapWS (which may utilize download functions, e.g., utilizing the concatenation function, to download one or more of the A, B, and/or objectives files);

9. Map (which may include data to be copied by the user to the appropriate course map (e.g., depending on the category)); and/or

10. Index (which may include HTML data to be copied by the user into the index map).

With respect to the Map worksheet, in an embodiment, there can be several course maps, each one containing information and/or links to resources, for example, limited to the current courses within a specified category. The map worksheet may produce HTML code, which can be used to create one table row, for example, in an HTML file (referred to as a map, e.g., JavaMap.html). When viewed in a browser, the row for each course may include any combination of the following:

a. course number (e.g., ID);

b. course name;

c. link to download the A file;

d. link to download the B file; and/or

e. link to download the objectives file.

With respect to the Index worksheet, in one embodiment, there can be one index map, which includes information, for example, only for all current courses in the skills database. The Index worksheet may produce HTML code, which can be used to create, for example, one text row in an HTML file. When viewed in a browser, the row for each course may include any combination of the following:

a. course number (e.g., ID);

b. course name; and/or

c. course domain ID (e.g., the location in the skills database).

In an embodiment, most or all of the entries described may be copied and pasted. The source of the data may be the objectives file discussed herein. In addition, the user may prepare the objectives file from course source materials before using the Course Builder tool. In one embodiment, after the A and B checks are done, in case of an error (such as a length violation, incorrect data type, e.g., numerals versus alphabetical information, and the like), the cell causing the error may be identified to, for example, allow the user to make modifications prior to loading the data. In another embodiment, the MapWS may produce one line of HTML code, which can then be used to download a file from the course map, for example.

III. Role Builder Embodiment

Role Builder is an implementation of Page Author in accordance with an embodiment of the present invention. In an embodiment, Role Builder can be used to facilitate the process of adding new roles to a skills database (such as the SunSkills database provided by Sun Microsystems, Inc., of Santa Clara, Calif.) and how related information may be made available to the users of the skills database. Accordingly, Role Builder may build several files or parts of files related to roles that are subsequently used in or related to courses (or learning events) in the skills database.

In one embodiment, Role Builder builds one CSV file that can be used to bulk load role data into the skills database. The CSV file may be available to consultants for download on the corporate intranet and/or the Internet. In a further embodiment, Role Builder also builds the HTML code for two files. It builds one complete HTML file and part of another. These three outputs are described next.

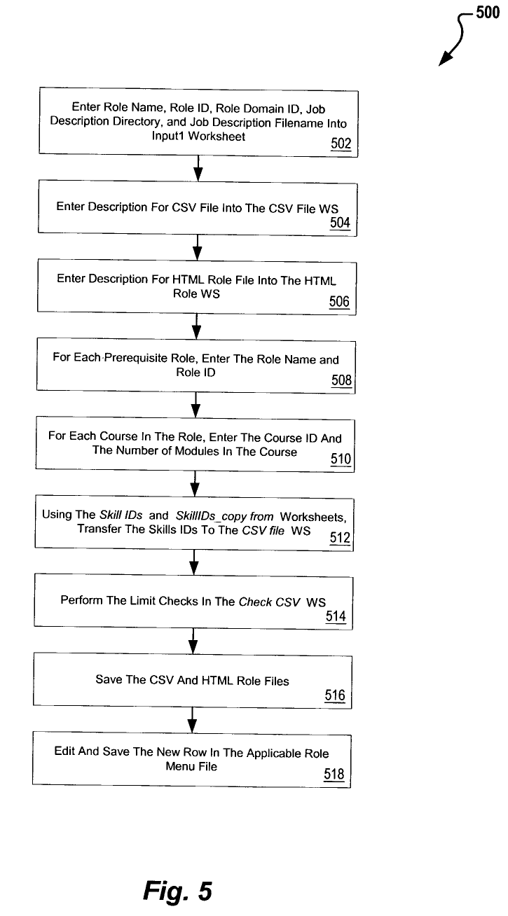

FIG. 5 illustrates an exemplary user responsibility method 500 in accordance with an embodiment of the present invention. The method 500 includes a step 502 to enter role name, role ID, role domain ID, job description directory, and job description filename into an Input1 WS. In a step 504, the user may enter the description for a CSV file into the CSV file WS. A step 506 enters the description for an HTML role file into an HTMLRole WS. In a step 508, for each prerequisite role, the role name and role ID are entered. In a step 510, for each course in the role, the course ID and the number of modules in the course are entered. In a step 512, using the Skill IDs and SkillIDs_copy from worksheets, the skills IDs are transferred to the CSV file WS. In a step 514, the limit checks in the Check CSV WS are performed. A step 516 saves the CSV and HTML role files. In a step 518, the user may edit and save the new row in the applicable role menu file.

In one embodiment, the first output of the Role Builder is the data for a CSV file that is subsequently loaded into the skills database. The appropriate data (which may be color-coded in an embodiment) may be copied into a text editor and saved with an appropriate filename.

The generated menu and the role map may be published on the corporate intranet and/or the Internet to be used by the consultants that may also use the data loaded into the skills database to deliver role assessments to customers. In a further embodiment, a single map may be linked to other role maps and role menus. This may allow the consultants to download job description files in a choice of two file formats, for example. These files may be produced prior to using Role Builder. Finally, the map may link to a localization file and instructions for using the localization file. The localization file can be the CSV file used to load the data into the skills database. Consultants in non-English speaking countries can download it, translate specified fields, and return it for loading into the skills database.

It is envisioned that in an embodiment Role Builder users enter most of the data in two worksheets. The first worksheet (e.g., Input1) may include any combination of the following five fields: role name, role ID, job description filename, code for role domain ID, and/or code for job description directory. In one embodiment, codes may be entered from the Domain choices and Directory choices tables. The values for the Role domain ID and the Job description directory may be selected based on a result of the code.

The second worksheet (e.g., Input2) may include user-entered information regarding prerequisite roles and courses. Prerequisite roles refer to assessments that customers might have to take prior to a specified role. The courses are those that contain skills assessed in a specific role. The number of modules entered for each course is helpful for building the correct number of Skill IDs to be loaded into the database.

In another embodiment, Role Builder may also include a number of worksheets that can be used to process information between the inputs and outputs. Some of the major tasks accomplished by this processing may include:

1. creating the date of loading data into the database;

2. creating various links of the role map and role menu; and/or

3. controlling the HTML code for a variable number of:

a. prerequisite roles; and/or

b. courses comprising the role.

In an embodiment, it is envisioned that the background of the person making the HTML documents should include familiarity with the use of spreadsheets and text files. That person should also be versed in using various required functions of the spreadsheet program utilized. In another embodiment, a person with sufficient spreadsheet abilities may design the initial spreadsheet, while another person or team of people with a user-level expertise can produce the HTML documents from the templates already created.

The foregoing description has been directed to specific embodiments. It will be apparent to those with ordinary skill in the art that modifications may be made to the described embodiments, with the attainment of all or some of the advantages. For example, even though different worksheets are specified when discussing embodiments of the present invention, it is envisioned that different areas, portions, and/or sections of a same worksheet may be utilized. Therefore, it is the object of the appended claims to cover all such variations and modifications as come within the spirit and scope of the invention.

What is claimed is:

1. A method of providing a plurality of Web pages, the method comprising:
building an initial Web page corresponding to the plurality of Web pages;
providing an input section to enter data into;
providing an output section to output data to;
providing a process section to process data based on the input section data and output the processed data to the output section;
identifying variable data present in the initial Web page; and
creating at least one formula in the output section to reconstitute code corresponding to the identified variable data,
wherein the reconstituted code assists in provision of the plurality of Web pages and the plurality of Web pages provide at least one of a same look and a same feel.

2. The method of claim 1 further including creating at least one function in the process section to assist in provision of data in the output section.

3. The method of claim 1 wherein the initial Web page is built utilizing a Web authoring program.

4. The method of claim 3 wherein the Web authoring program is selected from a group comprising FrontPage, Adobe GoLive, Adobe PageMill, Dreamweaver, HotDog, and HoTMetaL Pro.

5. The method of claim 1 further including adding a user instruction to one of the items selected from a group comprising the input section, the output section, and the process section.

6. The method of claim 1 further including adding a help tip to one of the items selected from a group comprising the input section, the output section, and the process section.

7. The method of claim 1 further including adding a filename formula to the output section.

8. The method of claim 1 wherein at least one color is utilized to distinguish two of the input, output, and process sections.

9. The method of claim 1 wherein the input, output, and process sections are implemented as separate areas in a spreadsheet application.

10. The method of claim 9 wherein the separate areas are implemented as a plurality of worksheets.

11. The method of claim 9 wherein the spreadsheet application is selected from a group comprising StarCalc, Microsoft Excel, Microsoft Works, Quattro Pro, ClarisWorks, AppleWorks, and Lotus 123.

12. An article of manufacture for providing permissions management, the article comprising:
a machine readable medium that provides instructions that, if executed by a machine, will cause the machine to perform operations including:
building an initial Web page corresponding to a plurality of Web pages;
providing an input section to enter data into;
providing an output section to output data to;
providing a process section to process data based on the input section data and output the processed data to the output section;
identifying variable data present in the initial Web page; and
creating at least one formula in the output section to reconstitute code corresponding to the identified variable data.

13. The article of claim 12 wherein the operations further include creating at least one function in the process section to assist in provision of data in the output section.

14. The article of claim 12 wherein the operations further include adding a user instruction to one of the items selected from a group comprising the input section, the output section, and the process section.

15. The article of claim 12 wherein the operations further include adding a help tip to one of the items selected from a group comprising the input section, the output section, and the process section.

16. The article of claim 12 wherein the operations further include adding a filename formula to the output section.

17. A system for providing a plurality of Web pages, the system comprising:
an initial Web page builder to build an initial Web page corresponding to the plurality of Web pages;
an input section to enter data into;
an output section to output data to;
a process section to process data based on the input section data and output the processed data to the output section;
a variable data identifier to identify variable data present in the initial Web page; and
at least one formula in the output section to reconstitute code corresponding to the identified variable data,
wherein the reconstituted code assists in provision of the plurality of Web pages and the plurality of Web pages provide at least one of a same look and a same feel.

18. The system of claim 17 further including at least one function in the process section to assist in provision of data in the output section.

19. The system of claim 17 wherein the initial Web page builder is selected from a group comprising FrontPage, Adobe GoLive, Adobe PageMill, Dreamweaver, HotDog, and HoTMetaL Pro.

20. The system of claim 17 further including a filename formula in the output section.

21. The system of claim 17 wherein at least one color is utilized to distinguish two of the input, output, and process sections.

22. The system of claim 17 wherein the input, output, and process sections are implemented as separate areas in a spreadsheet application.

23. The system of claim 22 wherein the separate areas are implemented as a plurality of worksheets.

24. The system of claim 22 wherein the spreadsheet application is selected from a group comprising StarCalc, Excel, Microsoft Works, Quattro Pro, ClarisWorks, AppleWorks, and Lotus 123.

25. An apparatus for providing a plurality of Web pages, the apparatus comprising:
means for building an initial Web page corresponding to the plurality of Web pages;
input section means for entering data into;
output section means for outputting data to;
process section means for processing data based on the input section data;
means for identifying variable data present in the initial Web page; and
at least one formula in the output section means to reconstitute code corresponding to the identified variable data.

26. The apparatus of claim 25 further including means for providing data in the output section.

27. The apparatus of claim 25 further including means for providing a plurality of filenames for the plurality of Web pages.
